(19) United States
(12) Patent Application Publication
(10) Pub. No.: US 2009/0006660 A1
(43) Pub. Date: Jan. 1, 2009

(54) AGGREGATION OF DEVICES FOR A MULTIMEDIA COMMUNICATION SESSION

(75) Inventors: Anthony J. Bawcutt, Kirkland, WA (US); Timothy M. Moore, Bellevue, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/769,779

(22) Filed: Jun. 28, 2007

(51) Int. Cl. G06F 3/00

(52) U.S. Cl. 710/18

(57) ABSTRACT

A system that facilitates aggregation of devices for a multimedia communication session (e.g., voice, video, audio, graphics) is disclosed. In particular, the innovation can automatically separate a multimedia input into individual streams thereafter facilitating the selection of appropriate devices for which to render the input so as to maintain the multimedia communication experience. Logic is provided to assist in the selection the devices from a network of user-available devices.

### BACKGROUND

Technological advances in the computing space are constantly being developed to provide users with a vast array of tools to enhance business productivity, entertainment and communications. Both enterprises and individuals are increasingly interested in using handheld and portable devices such as mobile telephones, personal data assistants (PDAs), notebook computers, handheld computers, laptop computers, etc. Most often, a user employs multiple devices in every activity. Today, most modern cell phones are equipped with the ability to playback multimedia data such as music videos, internet television, etc. However, currently there are no applications that leverage this functionality by integrating these capabilities in the area of communications, such as VoIP (voice over internet protocol).

Today, cellular telephones running on state-of-the-art operating systems have increased computing power in hardware and increased features in software in relation to earlier technologies. For instance, cellular telephones are often equipped with built-in digital image capture devices (e.g., cameras) and microphones together with computing functionalities of personal digital assistants (PDAs) and capabilities of personal media players. These devices that combine the functionality of cellular telephones with the functionality of PDAs and media players (e.g., audio, video) are commonly referred to as ‘smartphones.’

The hardware and software features available in these smartphones and similar technologically capable devices provide developers the capability and flexibility to build applications through a versatile platform. The increasing market penetration of these devices inspires programmers to build applications, Internet browsers, etc. for these smartphones. Unfortunately, applications do not exist that expose the full potential of these devices. Additionally, applications do not exist that leverage the ability of these devices to integrate with other computing devices such as laptops, desktops, television monitors, etc.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that facilitates aggregation of devices for a multimedia communication session (e.g., voice, video, audio, graphics). In other words, the innovation can automatically evaluate an input and determine appropriate devices for which to render portions of the input so as to maintain the multimedia communication experience. A profile (e.g., rule) or inference-based decision logic can be employed to determine the appropriate devices from an inventory or network of suitable devices.

In aspects, the inventory of devices can be established based upon login information as well as other contextual factors (e.g., location). Similarly, contextual awareness can be employed to intelligently determine an appropriate set of devices to employ in the communication experience. When using multiple devices to render a multimedia communication session, the innovation enables synchronization of the media rendered upon disparate devices. Thus, the session can continue seamlessly via multiple devices.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates aggregation of devices related to a multimedia input in accordance with an aspect of the innovation.

FIG. 2 illustrates an example flow chart of procedures that facilitate analyzing, separating and transmitting media streams in accordance with an aspect of the innovation.

FIG. 3 illustrates an example flow chart of procedures that facilitate establishing and maintaining a device inventory in accordance with an aspect of the innovation.

FIG. 4 illustrates an alternative block diagram of a system that facilitates aggregating devices in accordance with an aspect of the innovation.

FIG. 5 illustrates an example input analysis component that facilitates evaluation and separation of a multimedia input in accordance with an aspect of the innovation.

FIG. 6 illustrates an example device management component that facilitates device selection and media transfer in accordance with an aspect of the innovation.

FIG. 7 illustrates an example device selection component that employs one of logic or machine learning/reasoning mechanisms to select appropriate devices in accordance with an aspect of the innovation.

FIG. 8 illustrates an example inventory management component that facilitates establishment and management of a device inventory in accordance with an aspect of the innovation.

FIG. 9 illustrates an example media transfer component that synchronizes media of disparate types in accordance with an aspect of the innovation.

FIG. 10 illustrates an architecture including a machine learning/reasoning-based component that can automate functionality in accordance with an aspect of the novel innovation.

FIG. 11 illustrates an architecture of a system that facilitates generation of a device profile component in accordance with an aspect of the innovation.

FIG. 12 illustrates a block diagram of a computer operable to execute the disclosed architecture.

FIG. 13 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

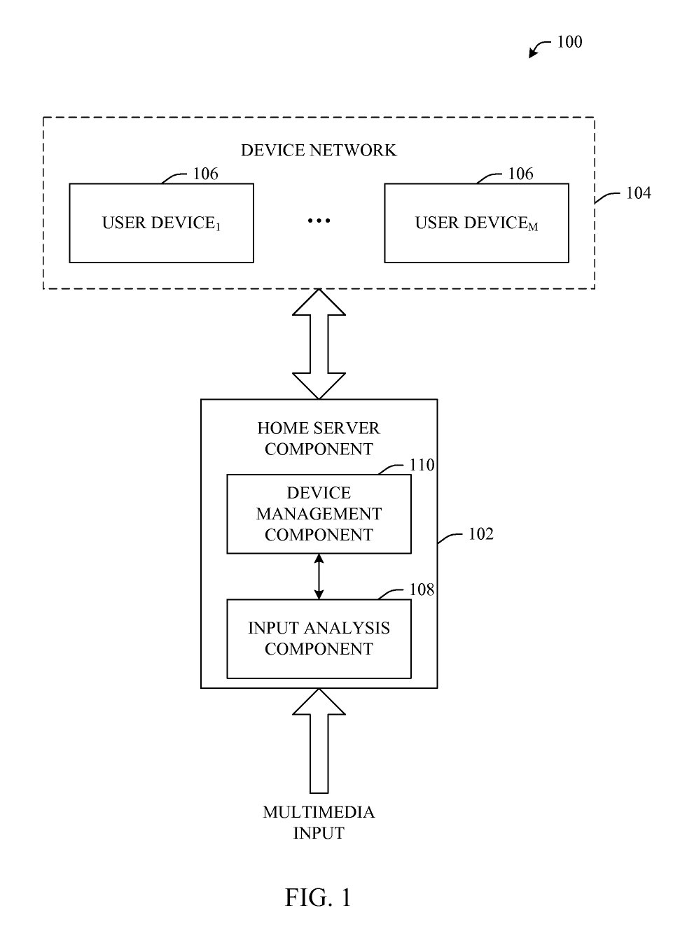

Referring initially to the drawings, FIG. 1 illustrates a system 100 that facilitates device aggregation with regard to multimedia communication sessions. As used herein, multimedia refers to data and information in more than one form or format. For example, multimedia can include the use of text, audio, graphics, animated graphics and full-motion video. More specifically, the innovation discloses systems and methods which facilitate the handling or management of multimedia communication sessions. While voice-over-internet protocol (VoIP) is relatively commonplace in the art, multimedia communication sessions continue to develop and gain popularity. Accordingly, the innovation described herein discloses mechanisms by which these multimedia communication sessions can be rendered on more than one device simultaneously thereby leveraging functionality of a number of disparate devices.

Generally, the system 100 can include a home server component 102 that maintains and manages devices associated to a user. These devices can be referenced within a device network 104. As illustrated, 1 to M user devices 106 are shown, where M is an integer. In operation, the system 100 can populate the device network upon active login by a user. In other words, as a user logs into a device or machine, the device network 104 can be updated with the characteristics of such device(s) and machine(s). While many of the examples that follow are directed to triggering addition of a user device 106 to the device network 104 upon login, it is to be understood that other aspects exist that can dynamically populate the device network based upon most any contextual factor. For example, location of a user can be monitored and tracked such that available devices within a predefined range of proximity can be automatically made available for use in accordance with the subject functionality. This concept of populating and employing devices 106 from the device network 104 will become apparent upon a review of the figures that follow.

As shown, home server component 102 can include an input analysis component 108 and a device management component 110. Although illustrated as a standalone component, it is to be understood that the home server component 102 can be integrated into one or more of the devices 106. Thus, if integrated within one device 106, that device 106, can be employed to manage distribution of communication streams to other devices 106 within the device network 104. Similarly, if home server 102 is employed in each of the devices 106, each device can automatically distribute communication streams to the appropriate available devices 106 which are capable of rendering a particular stream.

The input analysis component 108 can receive a multimedia input and thereafter separate the input into most any number of appropriate streams. By way of example, suppose the multimedia input is a conventional voice-over-internet protocol (VoIP) communication coupled with a video stream. Here, the input analysis component 108 can separate the streams (e.g., voice and video). Accordingly, each stream can be sent to an appropriate device 106 for rendering. While the examples describe the ability for multiple devices to handle a single communication, it is to be understood that other aspects exist where a single device is employed to render multiple media types.

The device management component 106 can be employed to determine to which devices (or single device) the input streams should be sent. Continuing with the above example, the VoIP (e.g., voice) stream can be sent to cellular phone where the video portion or stream is sent to a desktop computer thereby rendering the complete multimedia experience upon multiple devices 106. It will be understood upon a review of the figures that follow that the home server component 102 (or the device management component 110) is capable of synchronizing the streams so as to match timing of the streams. For instance, the caller's spoken words on the audio portion will match the visual images of the caller regardless of the number of devices employed.

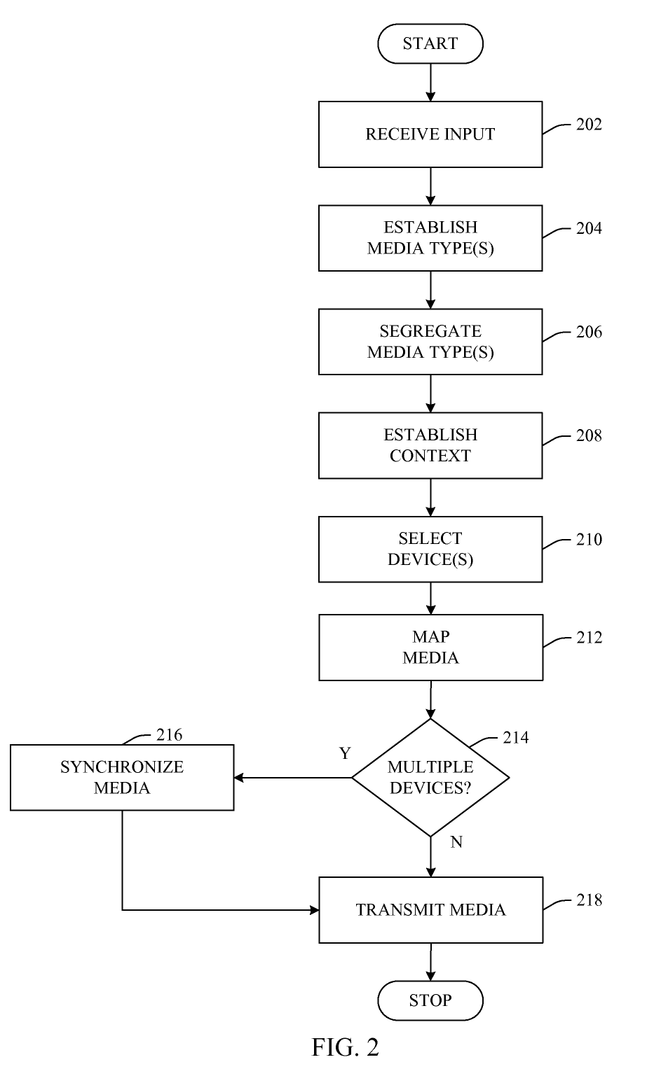

FIG. 2 illustrates a methodology of managing multimedia communication sessions in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, a multimedia input can be received. In alternate aspects, multiple inputs can be received from one or more sources. The multimedia input can include most any media type including, but not limited to, voice (or other audio), video, text, graphics, etc. The media types can be established at 204 by analyzing the input stream(s).

At 206, the input (or inputs) can be segregated into multiple media types. Continuing with the aforementioned example, separate communication streams can be established for each media type. For instance, a stream can be established for the voice portion of the input and a separate stream for the video portion of the input.

Optionally, at 208, a context can be established to assist in the management of the communication streams. For example, the context can be established in accordance with information received via a global positioning system (GPS) whereby a user location, time of day, date, etc. can be established. This information can be employed to select appropriate devices at 210. In other aspects, in addition to or rather than establishing a context, a user profile or rule can be accessed in order to facilitate selection of appropriate devices at 210. The rule(s) can effectuate selection as a function of media type, preference, location, time of day, engaged activity, etc.

Once the devices are selected at 210, the media is mapped to the appropriate device, for example, based upon type, context, etc. at 212. At 214, a decision can be made to determine if multiple devices are being used to render the multimedia stream. If multiple devices are used, at 216, the media streams are synchronized and played back at 218. As well, it is to be understood that synchronization may be employed in the scenario of a single communication device. In either case, it is important to understand that synchronization can be employed to establish a seamless playback of the media.

While some conventional endpoints cannot handle multiple media types, it is useful to be able to map specific streams to devices capable of handling the particular media type. For example, sometimes a personal computer (PC) is not equipped with a microphone. In these cases, if a VoIP call is received that is accompanied by video or even a graphics slide show (e.g., teleconference), the voice portion of the call can be automatically transferred to a cell phone while the graphics portion can be rendered via the PC. As described above, the transfer can triggered automatically based upon a user profile or inference (e.g., machine learning and reasoning (MLR)) mechanism.

In other aspects, notifications can be sent to user devices (e.g., 106 of FIG. 1) whereby a user can ‘accept’ use of the particular device 106 for an appropriate portion or portions of the call. Alternatively, decisions can be made automatically on behalf of a user based upon a profile or other logic (e.g., MLR) mechanisms. Moreover, it is to be understood that the notification can be of most any type including but, not limited to, vibratory, audible, visual, etc.

In another example, suppose a user receives a multimedia communication with regard to a corporate teleconference. Here, the user may choose to transfer the audio to a VoIP speakerphone in the room while transferring the accompanying video or graphics (e.g., slide deck) to a conference room video unit for public display. Furthermore, it is to be understood that a user interface can be provided that enables transfer between devices. For instance, if a user exits a room, it is possible to transfer media back to the portable device from a device located in a room (e.g., conference room VoIP speaker phone back to a handheld smartphone). This transfer can be triggered by a user or automatic as a function of a user context (e.g., location).

Additionally, it is to be understood that it is possible to render multiple sessions of the same media. For instance, a user may want to engage in a call on a smartphone while maintaining a copy of the voice and audio on a desktop PC. Here, the voice portion of the call can be transferred to the mobile device where the video portion along with the voice portion can be captured on the desktop PC for later reference. This archiving ability can be triggered or set as a default as desired. Similarly, much like the logic of automatically transferring streams to selected devices, the archive functionality can be context based. For example, the system can infer a desire to archive from an identity of a caller, a current activity of a user, content of the multimedia input or the like.

Overall, the innovation enables determination of available user devices. This determination can be login-based, context-based, preprogrammed, inferred, etc. Once the devices are determined, the innovation discloses the ability to trigger notifications on a particular device, for example a ring tone. Similarly, once a call is answered on a particular device, the system can dismiss other notifications on disparate devices as appropriate or desired. Alternatively, the system can also require a cancellation acknowledgement on each device if desired. Still further, the innovation enables media to be transferred, consolidated, aggregated or dismissed from a number of appropriate devices (e.g., device network 104 of FIG. 1).

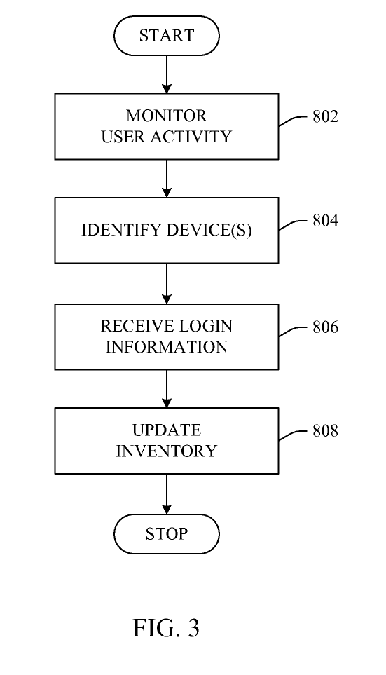

Referring now to FIG. 3, there is illustrated a methodology of establishing a device network (e.g., 104 of FIG. 1) in accordance with the innovation. At 802, user activity is monitored. In a particular example, a user can be monitored to determine which devices are available to a user. At 804, each of the devices is identified. For example, mobile devices as well as stationary devices can be identified in proximity of a user.

Once a user logs into a subset of the devices, login information can be received at 806. This login information identifies which machines or devices have been logged into by the user. Accordingly, the device inventory can be updated at 808 as a function of the login information. Alternatively, the inventory can be updated at 808 as a function of the proximate machines and/or devices. In other words, the inventory of available devices can be determined as a function of device location in relation to user location, which can be established at 802. In this aspect, the inventory of available devices can dynamically change in accordance with a user location or other contextual factors (e.g., engaged activity, time of day, calendar data).

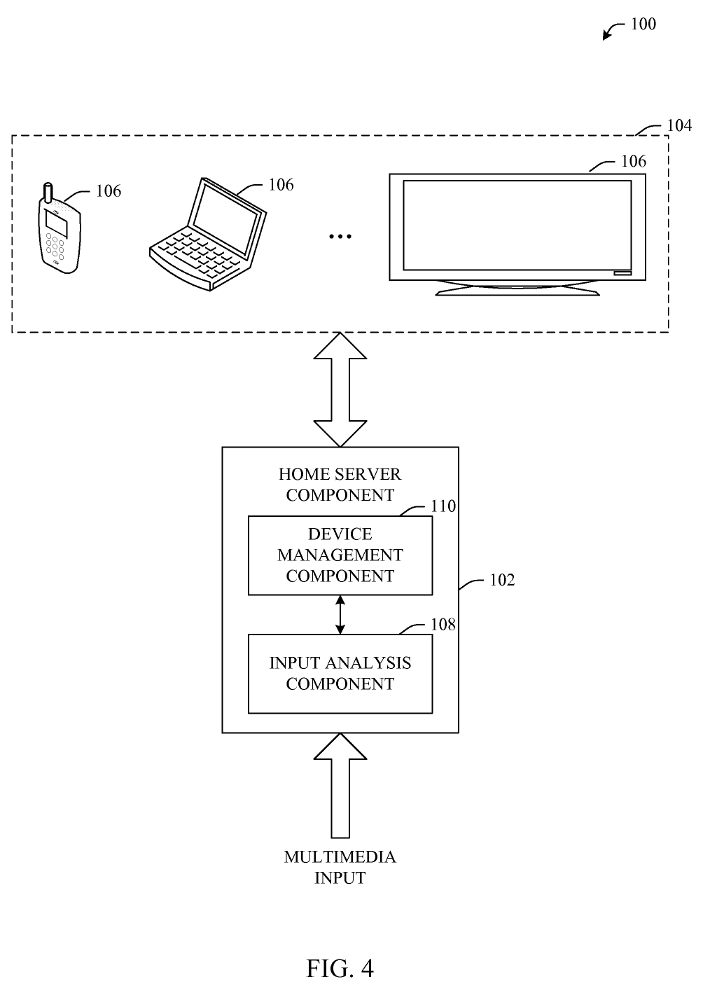

FIG. 4 illustrates an alternative block diagram of system 100 in accordance with the innovation. More particularly, FIG. 4 illustrates user devices 106 that can include, but are not limited to include, smartphones, laptop computers, monitors, etc. In operation, a subset of these devices 106 can be aggregated and synchronized to enable seamless playback of a multimedia communication session.

Moreover, as described above, it is to be understood that the system 100 can be configured to automatically archive or record a multimedia communication session (or portion thereof). For instance, although the voice portion may be rendered via the smartphone while the video is rendered via a monitor, both segments can automatically be sent to a computer (e.g., laptop) for archive. It is to be understood that countless examples exist that employ the functionality of segregating multimedia inputs. Additional, countless examples exist as to the combinations of devices by which to render the segregated portions of the multimedia input. These countless examples are to be included within the scope of the innovation and claims appended hereto.

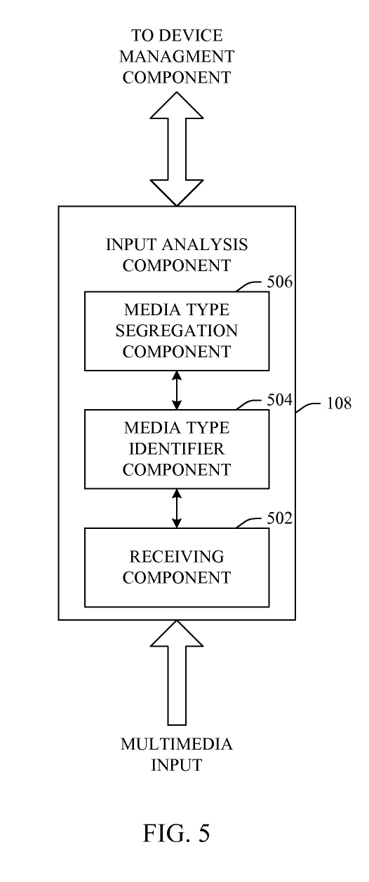

FIG. 5 illustrates a block diagram of an input analysis component 108 in accordance with the innovation. Generally, the input analysis component 108 can include a receiving component 502, a media type identifier component 504 and a media type segregation component 506. As illustrated, in operation, the receiving component 502 accepts or otherwise obtains a multimedia input where the input represents a communication session having at least two media types associated therewith. As described above, the multimedia input can include streams or data including, but not limited to, voice (e.g., VoIP), video, graphics, text, etc.

The media type identifier component 504 can be employed to establish the types of media included within the input. For example, a video call would have both a voice stream and a video stream associated therewith. In the event that a slide show or other graphic is employed, this type of media stream will be identified as well. For instance, if a slide show is included in the multimedia input, the media type identifier component 504 can identify it as such and can also identify appropriate software applications that can render the media stream. This information can be used to determine appropriate devices to aggregate to effect playback.

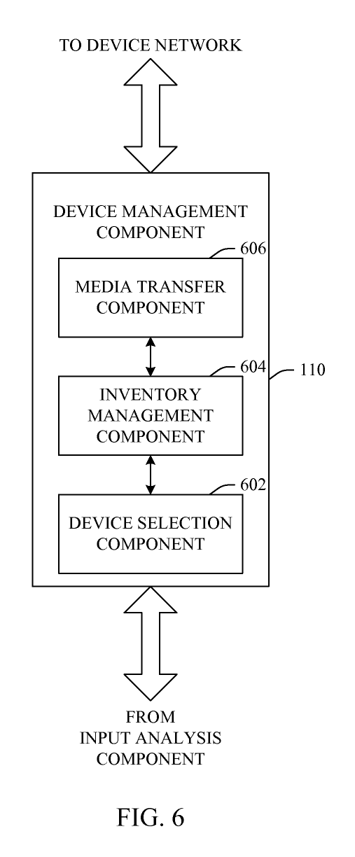

The media type segregation component 506 can be used to separate the media inputs from the multimedia input. Continuing with the above example, the voice input can be separated from the video input so as to enable each input to be handled separately. For example, the voice input can be sent to a VoIP-equipped phone while the video can be sent to a media center monitor. This transfer of media can be effectuated by the device management component 110 illustrated in FIG. 6.

Referring now to FIG. 6, an example device management component 110 in accordance with an aspect of the innovation is shown. As shown, the device management component 110 can include a device selection component 602, an inventory management component 604 and a media transfer component 606. In operation, the device selection component 602 can identify appropriate devices as a function of the media types included within the multimedia input. Additionally, the device selection component can employ logic in selecting the appropriate devices. The logic can be a function of decisions made on-the-fly or based upon some predetermined policy.

The inventory management component 604 can make an inventory of devices available to the device selection component 602. This inventory can be dynamically updated as a function of most any factor including, but not limited to, user login information, engaged activity, location, time of day, devices or users in proximity, etc. Each of these examples is to be included within the scope of the disclosure and claims appended hereto.

The media transfer component 606 can facilitate transferring the media to the appropriate devices selected by the device selection component 602. This transfer can be effectuated automatically (e.g., on behalf of a user) based upon a predefined profile and/or intelligence (e.g., MLR). Additionally, the transfer can be affirmatively triggered by a user in response to a system generated notification. For instance, when a multimedia call is received, a notification can be sent to one or more user devices (as determined by the device selection component 602). In response, the user can agree to accept the call on any subset of the devices by acknowledging (e.g., answering) the call.

Logic can be employed to automatically accept, cancel or continue a notification based upon the input type(s) in view of the answering device capabilities. For instance, if the voice portion of a call is accepted on a cellular telephone, the media portion notification can continue on a suitable device until either accepted or denied. For example, a notification for the video portion of a call can continue on a laptop computer, a desktop PC or even a media center monitor. This notification can be automatically set to ‘time out’ if not accepted or denied within a defined threshold of time.

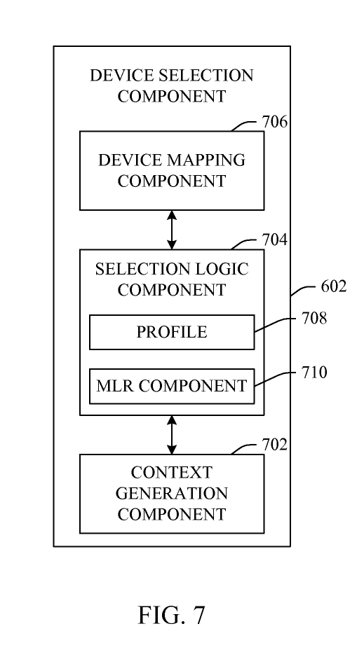

Referring now to FIG. 7, a block diagram of an example device selection component 602 is shown. Generally, the device selection component 602 can include a context generation component 702, a selection logic component 704 and a device mapping component 706. Together, these components can enable a logical selection of appropriate devices based upon a particular input type.

The context generation component 702 can be employed to establish contextual awareness related to a user and/or the incoming media stream(s). For example, the context generation component 702 can be employed to gather contextual data associated to a user, device and/or particular input (e.g., type, sender). By way of example, the component 702 can establish location of a user as well as the engaged activity of a user. This information can be used in determining appropriate devices to employ with regard to a particular input. Additionally, other data such as PIM (personal information management) data can be employed to establish a context. Effectively, it is to be understood that most any contextual factors about a user, device and/or input can be gathered and subsequently employed to effectuate selection of devices, if desired.

The selection logic component 704 can include a profile component 708 and/or an MLR component 710. Each of these subcomponents (708, 710) can be used to intelligently select appropriate devices to aggregate with regard to a particular input. The profile component 708 can maintain one or more rules that define which device to select based upon a particular media type, user preference, context, etc. Similarly, an MLR component 710 can be employed to infer a user preference thereby automatically effectuating selection of appropriate devices.

The device mapping component 706 can be employed to map or relate a segregated input to a particular device or set of devices. For example, the voice portion of a multimedia call can be mapped to a smartphone whereas the video portion can be automatically mapped to desktop PC. Moreover, it is to be understood that each portion can be mapped to more than one device, for example, a smartphone for interaction and a desktop PC for archive.

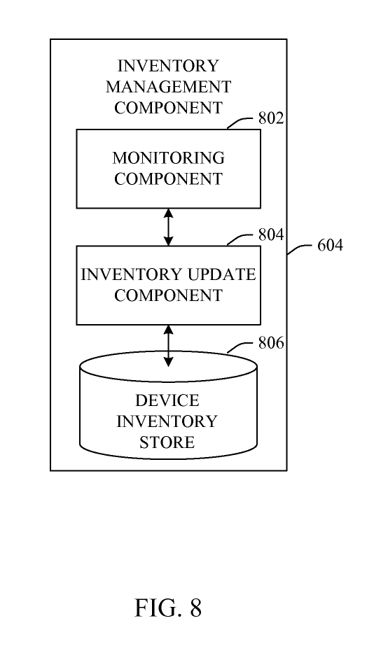

Turning now to FIG. 8, a block diagram of an example inventory management component 604 is illustrated in accordance with an aspect of the innovation. As shown, the inventory management component 604 can include a monitoring component 802 that facilitates monitoring activity of a user. For example, the monitoring component 802 can enable tracking device-based login information related to a particular user or group of users. Additionally, the monitoring component 802 can facilitate tracking the current location and/or activities of a user.

The inventory update component 804 can maintain a device inventory store 806 that relates to available devices which can be used to deliver multimedia communication data. The inventory update component 804 can employ information established by the monitoring component 802 to maintain (e.g., create, update, delete) entries within the device inventory store 806. While the device inventory store 806 is illustrated inclusive of the inventory management component 604, it is to be understood that the inventory management component 604 can be co-located with the device inventory store 806. Alternatively, the device inventory store 806 can be located remotely from the inventory management component 604 or even deployed in a distributed fashion as appropriate or desired.

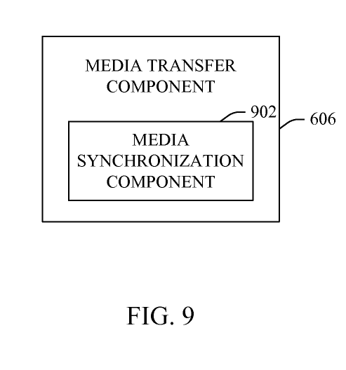

An example media transfer component 606 is illustrated in FIG. 9 having a media synchronization component 902 included therein. The media synchronization component 902 can be employed to synchronize media delivered as multiple streams whether to a single device or multiple devices. For example, when voice is delivered with video, it is useful to synchronize the streams such that the audio matches the video. Here, the media synchronization component 902 can be employed to effect this synchronization.

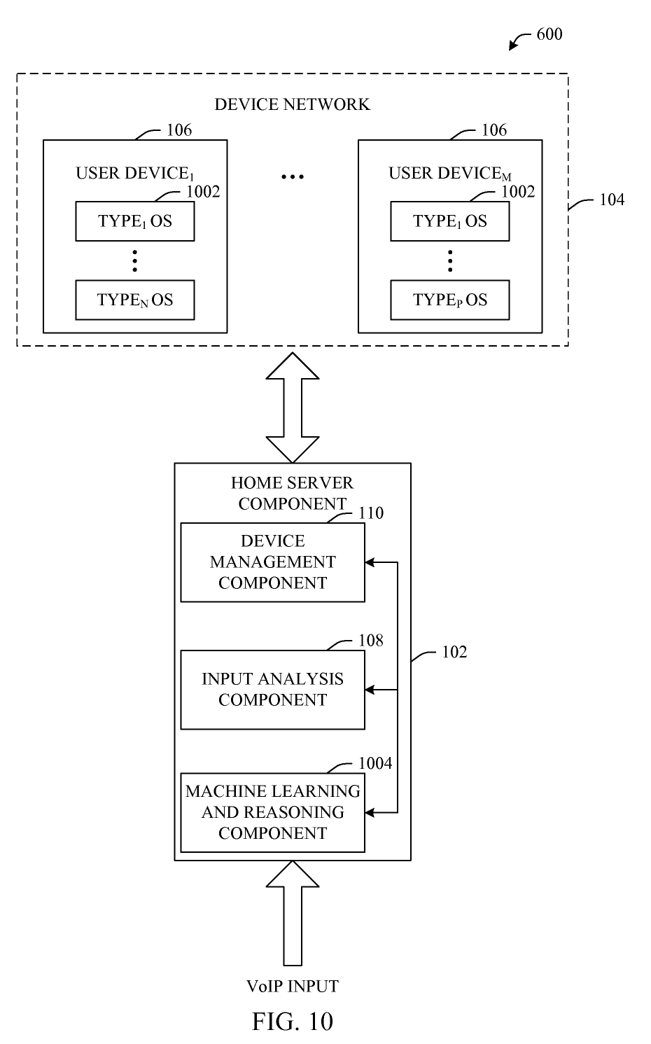

FIG. 10 illustrates an alternative block diagram of a system 600 that facilitates delivery of multimedia communication streams and data to disparate devices 106. As shown, each device can have an operating system (OS) directed to a specific media type. For example, a first device can have 1 to N type OS components where another device can have 1 to P type OS components, where N and P are integers. These type OS components 1002 can directly relate to the particular capabilities of the device 106. For example, if a user device 106 is capable of handling voice and video, a voice OS and a video OS can be employed within the device.

It is to be understood that this separation of OS functionality based upon media type can enhance performance as well as add redundancy in the case of a failure of one of the components. By way of example, if a particular device is being employed to render voice and video, if an unfortunate event renders the voice feed undeliverable, the voice can continue uninterrupted since the components are autonomous and not reliant upon each other.

With continued reference to FIG. 10, the system 600 can employ an MLR component 1004 which facilitates automating one or more features in accordance with the subject innovation. The subject innovation (e.g., in connection with device selection) can employ various MLR-based schemes for carrying out various aspects thereof. For example, a process for determining which devices to activate in response to a user context can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria which devices to activate based upon a context or media type, when to automatically archive media, when to split media, when/where to send a notification, when to cancel a notification, etc. Essentially, most any functionality described above can be automatically facilitated by way of an MLR component 1004. These alternative aspects are to be included within the scope of this disclosure and claims appended hereto.

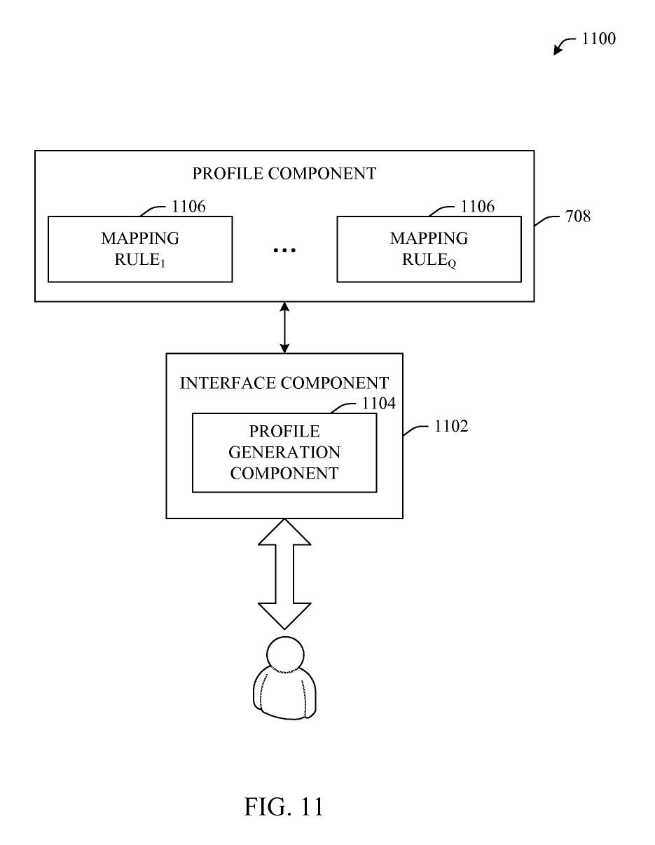

FIG. 11 illustrates a system 1100 that facilitates establishing the profile component 708. Generally, the system 1100 includes an interface component 1102 that employs a profile generation component 1104. The profile generation component 1104 enables a user to establish a profile component 708 having 1 to Q rules 1106 maintained therein, where Q is an integer. The rules 1106 can define mapping preferences as a function of media type, device type, context, or any combination thereof.

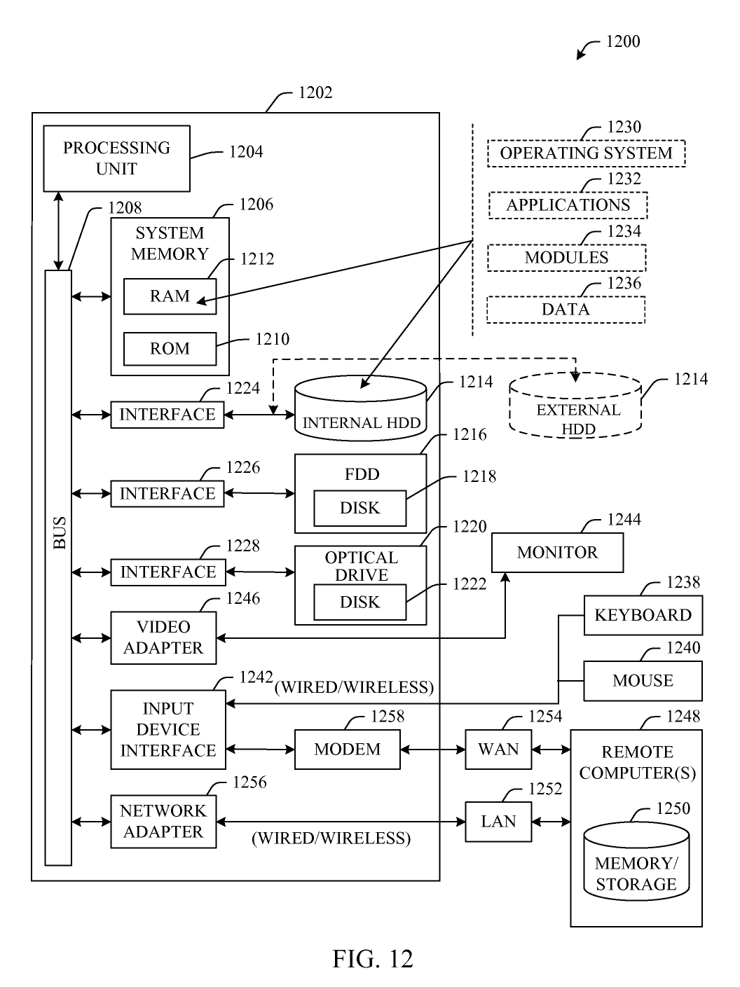

Referring now to FIG. 12, there is illustrated a block diagram of a computer operable to execute the disclosed architecture. In order to provide additional context for various aspects of the subject innovation, FIG. 12 and the following discussion are intended to provide a brief, general description of a suitable computing environment 1200 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects of the innovation includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the innovation can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1130 is illustrated. The logical connections depicted include wired/wireless connectivity to a local area network (LAN) 1132 and/or larger networks, e.g. a wide area network (WAN) 1134. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1132 through a wired and/or wireless communication network interface or adapter 1136. The adapter 1136 may facilitate wired or wireless communication to the LAN 1132, which may also include a wireless access point disposed thereon for communicating with the wireless adapter 1136.

When used in a WAN networking environment, the computer 1202 can include a modem 1138, or is connected to a communications server on the WAN 1134, or has other means for establishing communications over the WAN 1134, such as by way of the Internet. The modem 1138, which can be internal or external and a wired or wireless device, is connected to the system bus 1208 via the serial port interface 1242. In a networked environment, program modules depicted relative to the computer 1202, or portions thereof, can be stored in the remote memory/storage device 1130. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

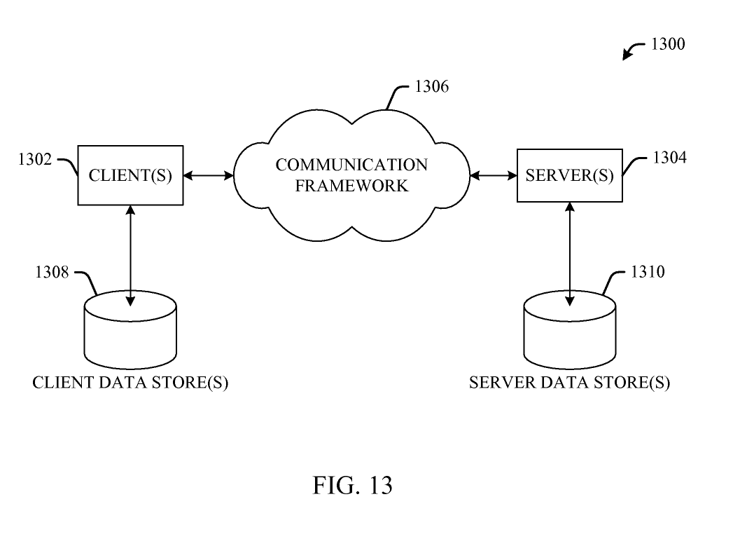

Referring now to FIG. 13, there is illustrated a schematic block diagram of an exemplary computing environment 1300 in accordance with the subject innovation. The system 1300 includes one or more client(s) 1302. The client(s) 1302 can be hardware and/or software (e.g., threads, processes, computing devices). The client(s) 1302 can house cookie(s) and/or associated contextual information by employing the innovation, for example.

The system 1300 also includes one or more server(s) 1304. The server(s) 1304 can also be hardware and/or software (e.g., threads, processes, computing devices). The servers 1304 can house threads to perform transformations by employing the innovation, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates aggregation of devices for a multimedia communication session, comprising:
a input analysis component that identifies at least two types within a multimedia input; and
a device management component that transfers data that corresponds to the at least to types to at least two devices.

2. The system of claim 1, further comprising a synchronization component that synchronizes the data that corresponds to the at least two types.

3. The system of claim 1, the at least two devices are at least two of a smartphone, a cell phone, a laptop computer, a desktop computer, a monitor or a roundtable camera.

4. The system of claim 1, the input analysis component comprises:
a receiving component that receives the multimedia input from a network; and
a media type identifier that identifies the at least two types from the multimedia input, wherein the at least two types are at least two of text, graphics, images, voice, video, instant message, SMS (short message service) or MMS (multimedia messaging service).

5. The system of claim 1, further comprising:
a device selection component that identifies the at least two devices from a device network as a function of the at least two types; and
a media transfer component that facilitates transfer of the data to each of the devices.

6. The system of claim 5, the device selection component employs context to identify the at least two devices.

7. The system of claim 5, the device selection component employs a user profile to identify the at least two devices.

8. The system of claim 5, the device selection component employs machine learning and reasoning mechanisms to infer the at least two devices.

9. The system of claim 5, further comprising an inventory management component that maintains a list of accessible devices, wherein the device selection component selects the at least two devices from the list of accessible devices.

10. The system of claim 9, further comprising:
a monitoring component that tracks user activity related to device access; and
an inventory update component that updates the list as a function of the user activity.

11. The system of claim 10, the inventory update component identifies capabilities of each device accessed by the user and stores the capabilities in the list, wherein the device selection component employs the capabilities to determine the at least two devices.

12. The system of claim 5, further comprising a device mapping component that maps the data to the at least two devices as a function of each of the at least two types.

13. The system of claim 1, further comprising machine learning and reasoning component that employs at least one of a probabilistic and a statistical-based analysis that infers an action that a user desires to be automatically performed.

14. A computer-implemented method of managing multimedia communication, comprising:
receiving a multimedia input;
separating the multimedia input into at least two data streams;
transferring the at least two data streams to at least two devices; and
synchronizing playback of the at least two data streams.

15. The computer-implemented method of claim 14, further comprising:
determining at least two media types from the multimedia input; and
identifying the at least two devices as a function of the at least two media types.

16. The computer-implemented method of claim 15, further comprising establishing a user context, wherein the user context is employed in transferring the at least two data streams.

17. The computer-implemented method of claim 15, further comprising:
monitoring user activity; and
updating a device inventory as a function of the user activity, wherein the device inventory is employed in identifying the at least two devices.

18. A computer-executable system that facilitates delivery of multimedia communication, comprising:
means for determining media types of the multimedia communication;
means for locating at least two user devices that correspond to the media types; and
means for transferring a portion of the multimedia communication that corresponds to each of the two user devices.

19. The computer-executable system of claim 18, further comprising means for synchronizing the portion of the multimedia communication transferred to each of the two user devices.

20. The computer-executable system of claim 19, further comprising:
means for establishing a context; and
means for employing the context to select the at least two user devices from a network of user devices.
